(19) United States
(12) Patent Application Publication
(10) Pub. No.: US 2005/0265588 A1
(43) Pub. Date: Dec. 1, 2005

(54) Method and system for digital image based flourescent in situ hybridization (FISH) analysis

(75) Inventors: Abhijeet S. Gholap, Cupertino, CA (US); Gauri A. Gholap, Cupertino, CA (US); C. V.K. Rao, Prune (IN); Madhura Vipra, Prune (IN); Deepak M. Pardeshi, Prune (IN); Prithviraj Jadhav, Prune (IN); Jayant Abhyankar, San Jose, CA (US)

Correspondence Address: Lesavich High-Tech Law Group, P.C., Suite 325, 39 S. LaSalle Street, Chicago, IL, 60603, US

(73) Assignee: Bioimagene, Inc., San Jose, CA (US)

(21) Appl. No.: 11/050,035

(22) Filed: Feb. 3, 2005

Related U.S. Application Data
(60) Provisional application No. 60/541,301, filed on Feb. 3, 2004.

(51) Int. Cl. G06K 9/00; G06K 9/46

(52) U.S. Cl. 382/128; 382/191

(57) ABSTRACT

A method and system for automated digital fluorescent in situ hybridization (FISH) image analysis. Luminance parameters from a digital image of a biological tissue sample to which a fluorescent compound (e.g., LSI-HER-2/neu and CEP-17 dyes) have been applied are analyzed to determine plural regions of interest. Fluorescent color signals in the plural regions of interest including plural cell nuclei are identified, classified and grouped into plural groups. Each of the plural groups is validated based on pre-defined conditions. A medical diagnosis or prognosis or medical, life science or biotechnology experiment conclusion determined using a count of plural ratios of validated fluorescent color signals within each of the cell nuclei within the plural groups.

### CROSS REFERENCES TO RELATED APPLICATIONS

This application claims priority to U.S. Provisional Application to U.S. Provisional patent application No. 60/541,301, filed Feb. 3, 2004. This application also claims priority to U.S. patent application Ser. No. 10/938,314, filed Sep. 10, 2004, which claims priority U.S. Provisional Patent Application No. 60/501,142, filed Sep. 10, 2003, and U.S. Provisional Patent Application No. 60/515,582 filed Oct. 30, 2003, and U.S. patent application Ser. No. 10/966,071, filed Oct. 23, 2004 which claims priority to U.S. Provisional Patent Application No. 60/530,714, filed Dec. 18, 2003, the contents of all of which are incorporated by reference.

### COPYRIGHT NOTICE

Pursuant to 37 C.F.R. 1.71(e), applicants note that a portion of this disclosure contains material that is subject to and for which is claimed copyright protection, such as, but not limited to, digital photographs, screen shots, user interfaces, or any other aspects of this submission for which copyright protection is or may be available in any jurisdiction. The copyright owner has no objection to the facsimile reproduction by anyone of the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### FIELD OF THE INVENTION

This invention relates to digital image processing. More specifically, it relates to a method and system for automated digital image based fluorescence in situ hybridization (FISH) analysis.

### BACKGROUND OF THE INVENTION

In the field of medical diagnostics and research, drug discovery and clinical trials, the detection, identification, quantification, and characterization of cells of interest, such as cancer cells, is an important aspect of diagnosis and research.

Pathologists use a number of properties in deciding the nature of a cell. Many of these properties do not have a rigid definition and many a times a pathologist provides a pathological decision based on many years of experience. A fundamental aspect of histopathology has been the recognition that the morphological appearance of a tumor can be correlated with a degree of malignancy. In many areas of histopathology, such as a diagnosis of breast carcinoma, does not give enough information for the referring medical clinician to make decisions about patient prognosis and treatment. Therefore manual and automated scoring and grading systems used by pathologists have been developed which provide additional information to medical clinicians. One of these automated scoring and grading systems includes considering cells.

It is observed that the seemingly simple task of counting cells of interest becomes difficult because the counting has to be done for large number of sections. Even experienced pathologist might miss genuine cells of interest due to fatigue. Examination of tissue images typically has been performed manually by either a lab technician or a pathologist. In the manual method, a slide prepared with a biological sample is viewed at a low magnification under an optical or fluorescent microscope to visually locate candidate cells of interest. Those areas of the slide where cells of interest are located are then viewed at a higher magnification to count those objects as cells of interest. In the last few years, slides with stained biological samples are photographed to create digital images from the slides. Digital images are typically obtained using an optical or fluorescent microscope and capturing a digital image of a magnified biological sample.

A digital image typically includes an array, usually a rectangular matrix, of pixels. Each “pixel” is one picture element and is a digital quantity that is a value that represents some property of the image at a location in the array corresponding to a particular location in the image. Typically, in continuous tone black and white images the pixel values represent a “gray scale” value.

Pixel values for a digital image typically conform to a specified range. For example, each array element may be one byte (i.e., eight bits). With one-byte pixels, pixel values range from zero to 255. In a gray scale image a 255 may represent absolute white and zero total black (or visa-versa).

Color images consist of three color planes, generally corresponding to red, green, and blue (RGB). For a particular pixel, there is one value for each of these color planes, (i.e., a value representing the red component, a value representing the green component, and a value representing the blue component). By varying the intensity of these three components, all colors in the color spectrum typically may be created.

However, many images do not have pixel values that make effective use of the full dynamic range of pixel values available on an output device. For example, in the eight-bit or byte case, a particular image may in its digital form only contain pixel values that fall somewhere in the middle of the gray scale range. Similarly, an eight-bit color image may also have RGB values that fall within a range some where in middle of the range available for the output device. The result in either case is that the output is relatively dull in appearance.

As is known in the art, Her-2/neu (C-erbB2) is a proto-oncogene that localizes to chromosome 17q. It encodes a transmembrane tyrosine kinase growth factor receptor. Protein product of this gene is typically over-expressed in breast cancer (e.g., 25-30%). This overexpression in majority of cases (e.g., 90-95%) is a direct result of gene amplification. Over-expression of Her-2/neu protein has prognostic significance for mammary carcinoma. Clinical studies in patients with breast cancer over the last decade have convincingly demonstrated that amplification/ overexpression of Her-2/neu is associated with a poor prognosis. Approximately 20-30% of invasive breast carcinomas are Her-2/neu amplified. Her-2/neu has also been shown to be increased in a variety of other human malignancies including kidney, and ovary.

For example, articles etitled “Comparison of HER2/neu Analysis Using FISH and IHC When Hercep Test Is Scored Using Conventional Microscopy and Image Analysis,” by Bloom et al., in Breast Cancer Research and Treatment, Proceedings of the 23rd Annual San Antonio Breast Cancer Symposium (San Antonio, Tex.: Cancer Therapy & Research Center, and University of Texas Health Science Center: 2000), 99.,“Her-2/neu (c-erbB-2) gene and protein in breast cancer”, by J. S. Ross and J. A. Fletcher J A in AM J Clin Pathol 1999; 112 (Suppl): S53-S67., “Fluorescent in situ hybridization for Flow imaging,” by Rosalynde J. Finch, David J. Perry and Brain E Hall:, Intl Soc for analytical cytology XXI congress, 2002.,“Studies of the Her-2/neu proto-oncogene in human breast and ovarian cancer” by D. R. Salmon et al Science (Wash D.C.) 1989; 24: 707-713., “Addition of Herceptin (humanized anti HER-2 antibody) to the first line chemotherapy for HER-2 over expressing metastatic breast cancer markedly increases anticancer activity; a randomized, multinational controlled phase III trial.”, by D. Salmon, et al., Proceedings of the American Society of Clinical Oncology 1998; 17: 98,. Yokota J, et al. “Amplification of c-erbB-2 oncogene in human adenocarcinomas in vivo” by Yokota J, et al. Lancet 1986; i: 765-767, “Quantitative FISH Image analysis” by Kenneth R. Castleman,. Sen Pathak (University of Texas M. D. Anderson Cancer Center), “An Approach to Quantitative Fluorescence in situ Hybridization in Thick Tissue Sections of Prostate Carcinoma” by Karsten Rodenacker-Michaela Aubele-Peter Hutzler-P. S. Umesh Adiga, GSF National Research Center for Environment and Health Institute of Pathology, Dept. Biomedical Image Analysis, all discuss the subject in detail.

Localisation of Her2/neu by immunohistochemistry (IHC) staining does not always correlate with increase in copy numbers of the Her-2/neu gene evident by Fluorescence in Situ Hybridization (FISH). In FISH analysis a fluorescently labeled oligonucleotide probe is added to a tissue sample on a microscope slide under conditions that allow for the probe to enter the cell and enter the nucleus. If the labeled sequence is complementary to a sequence in a cell on the slide a fluorescent spot will be seen in the nucleus when the cell is visualized on a fluorescent microscope. One advantage of FISH is that the individual cells containing the DNA sequences being tested can be visualized in the context of the tissue. It is more reliable and reproducible than IHC in demonstrating Her-2/neu status. A positive FISH result by itself, with or without IHC corroboration, is a significantly better discriminator of adverse prognosis

Evaluation of Her-2/neu has become all the more important with the development of Herceptin® (trastuzamab package insert) which directly targets the HER-2/neu protein and appears useful in late stage metastatic adenocarcinoma of the breast. Herceptin® (Trastuzumab) is FDA approved for first-line use in combination with paclitaxel for the treatment of HER2 protein overexpressing metastatic breast cancer in patients who have not received chemotherapy for their metastatic disease. When used first-line in combination with chemotherapy, Herceptin provides a significant survival benefit for patients with HER2-driven metastatic breast cancer.

Therefore, it is important to ensure the early identification of all patients who may benefit from Herceptin. (Herceptin® (Trastuzumab)full processing information; October 2003). Thus, the evaluation of HER-2/neu is clinically important for two things; the first is, as a predictive marker for response to Herceptin® therapy and the second is, as a prognostic marker. Her2-neu amplification is the criteria used to decide treatment with Herceptin. Accurate detection of Her-2/neu amplification by FISH is important in the prognosis and selection of appropriate therapy and prediction of therapeutic outcome.

The determination of the presence of amplification for the HER-2/neu oncogene is based on the counting of fluorescence signals for LSI-ER-2/neu (i.e., red/orange signal) and CEP-17 (i.e., green signal) contained within the interphase nuclei (stained with DAPI, blue or Propidium Iodide, orange/ red) of invasive carcinoma cells. Manufacturer's guidelines for nonamplified and amplified cells are based on enumeration of 20 interphase nuclei from tumor cells per target reported as the ratio of average HER-2/neu copy number to that of CEP-17.

A ratio of HER-2 to CEP 17 orange to green indicates the amplification level. A ratio one is considered as non-amplified. The ratio in the range one to two is low-amplified. The ratio two to four is moderately amplified. Ratio above four is highly amplified.

There have been several attempts provide fluorescence analysis of cells of interest. For example, In U.S. Pat. No. 5,018,209, entitled “Analysis method and apparatus for biological specimens,” that issued to Bacus teaches “a method and apparatus are provided for selecting and analyzing a subpopulation of cells or cell objects for a certain parameter such as DNA, estrogen, and then measuring the selected cells. The observer in real time views a field of cells and then gates for selection based on the morphological criteria those cells that have the visual parameter such as colored DNA or colored antigen into a subpopulation that is to be measured. The selected cells are examined by digital image processing and are measured for a parameter such as a true actual measurement of DNA in picograms. A quantitation of the measured parameter is generated and provided.”

U.S. Pat. No. 5,546,323, entitled “Methods and apparatus for measuring tissue section thickness,” that issued to Bacus et al. teaches “An apparatus and method for measuring the thickness of a tissue section with an automated image analysis system, preferably using polyploid nuclear DNA content, for subsequent use in analyzing cell objects of a specimen cell sample for the diagnosis and treatment of actual or suspected cancer or monitoring any variation in the nominal thickness in a microtome setting. An image of a measurement material, such as a rat liver tissue section, having known cell object attributes is first digitized and the morphological attributes, including area and DNA mass of the cell objects, are automatically measured from the digitized image. The measured attributes are compared to ranges of attribute values which are preestablished to select particular cell objects. After the selection of the cell objects, the operator may review the automatically selected cell objects and accept or change the measured cell object attribute values. In a preferred embodiment, each selected cell object is assigned to one of three classes corresponding to diploid, tetraploid and octoploid cell morphology and the measured DNA mass of the identified cell object fragments in the rat liver tissue section sample may be corrected. Next, the selected cell objects of the measurement material, e.g., DNA Mass, are then graphically displayed in a histogram and the thickness of the rat liver tissue section can be measured based upon the distribution.”

U.S. Pat. No. 5,526,258, entitled “Method and apparatus for automated analysis of biological specimens,” that issued to Bacus et al., teaches “An apparatus and method for analyzing the cell objects of a cell sample for the diagnosis and treatment of actual or suspected cancer is disclosed. An image of the cell sample is first digitized and morphological attributes, including area and DNA mass of the cell objects are automatically measured from the digitized image. The measured attributes are compared to ranges of attribute values which are pre-established to select particular cell objects having value in cancer analysis. After the selection of cell objects, the image is displayed to an operator and indicia of selection is displayed with each selected cell object. The operator then reviews the automatically selected cell objects, with the benefit of the measured cell object attribute values and accepts or changes the automatic selection of cell objects. In a preferred embodiment, each selected cell object is assigned to one of six classes and the indicia of selection consists of indicia of the class into which the associated cell object has been placed. The measured DNA mass of identified cell object fragments in tissue section samples may also be increased to represent the DNA mass of the whole cell object from which the fragment was sectioned.”

In combination with fluorescence in situ hybridization (FISH), Multiphoton microscopy can be used for multi-gene detection (multiphoton multicolour FISH). For example, an article titled “Multiphoton microscopy in life sciences” by Konig K. in Journal of Microscopy, 2000, Vol. 200 (Part 2): 83-104, in general indicates the state of microscopy in life sciences.

An article entitled “Quantitative FISH Image analysis”, Kenneth R. Castleman, Sen Pathak (University of Texas M. D. Anderson Cancer Center) discusses digital image correction methods to obtain accurate total fluorescence measurements for FISH-labeled structures. They used surface fitting and background subtraction for image flattening, grayscale linearization and normalization, and color compensation to prepare the images for computing integrated fluorescence brightness for each labeled structure of interest. Limitation of this method is the need for interactive labeling of structure of interest.

An article entitled, “An Approach to Quantitative fluorescence in situ Hybridization in Thick Tissue Sections of Prostate Carcinoma” by Karsten Rodenacker-Michaela Aubele-Peter Hutzler-P. S. Umesh Adiga, GSF National Research Center for Environment and Health Institute of Pathology, Dept. Biomedical Image Analysis, discusses a seed based segmentation of nuclei. A user has to take mouse to a nucleus and click on it. They have developed a seeded volume growing technique based on several size and shape constraints, to segment the cell nuclei and to automatically count the FISH signal per nuclei. After slight volume opening for noise reduction the image is subject to global segmentation. It is automatically thresholded on the basis of local histograms and the 3-D connected components of the resulting two level image are labelled. Cells which are out of focus and too complicated to segment are rejected from further evaluation. Also the cells which are at the border of the image are rejected since the completeness of such a cell nuclei can not be ascertained. Cells which are touching each other are first selected for semi-automatic segmentation. The center of such a cell is selected by clicking the mouse over approximate centroid. This point will act as a seed and the seed is grown in all the directions using the threshold derived from local histograms. Limitation of this approach is the need for locating approximate centroid.

Examination of FISH images typically has been performed manually by either a lab technician or a pathologist. In the manual method, a slide prepared with a biological sample is viewed at a low magnification under a fluorescent microscope to visually locate candidate cells of interest. Those areas of the slide where cells of interest are located are then viewed at a higher magnification to count those objects as cells of interest, such as tumor or cancer cells.

An article entitled “Automatic Signal Classification in Fluorescence In Situ Hybridization Images,” by Boaz Lerner, et al., in Cytometry 43: 87-93 (2001), teaches an approach that eliminates the need of auto-focusing, and instead relies on a neural network (NN)classifier that discriminates between in and out-of-focus images taken at different focal planes of the same field of view. Discrimination is performed by the NN, which classifies signals of each image as valid data or artifacts (due to out of focusing). The image that contains no artifacts is the in-focus image selected for dot count proportion estimation. This assay emphasizes on classification of real signals and artifacts. It does not indicate how one can achieve signal counting per nucleus. It is assumed that this separation is done. However, in practice, touching, overlapping nuclei is a major technical problem that image processing algorithms should address.

An article entitled ” Feature Representation and Signal Classification in Fluorescence In-Situ Hybridization Image Analysis” by Boaz Lerner et al in, IEEE TRANSACTIONS ON SYSTEMS, MAN, AND CYBERNETICS—PART A: SYSTEMS AND HUMANS, VOL. 31, NO. 6, NOVEMBER 2001, teaches feature sets are evaluated by illustrating the probability density functions (pdfs) and scatter plots for the features. The analysis provides first insight into dependencies between features, indicates the relative importance of members of a feature set, and helps in identifying sources of potential classification errors. Class separability yielded by different feature subsets is evaluated using the accuracy of several neural network (NN)-based classification strategies, some of them hierarchical, as well as using a feature selection technique making use of a scatter criterion. The complete analysis recommends several intensity and hue features for representing FISH signals. Represented by these features, around 90% of valid signals and artifacts of two fluorophores are correctly classified using the NN. This assay emphasizes on classification of signals and artifacts. Reported accuracy of 90% is not sufficient for field level samples. It does not indicate how one can achieve signal counting per nucleus. It is assumed that this separation is done. However, in practice, touching, overlapping nuclei is a major technical problem that image processing algorithms should address.

It is observed that the seemingly simple task of counting signals becomes difficult by the condition that the count has to be done related to a single cell nucleus. As far as these nuclei are isolated it is easy to estimate the membership of a signal to a nucleus. However in most tumor tissues this relation is difficult or even sometimes impossible to determine. This is valid for visual inspection and even more for computer based analysis specific methods. Therefore there is need to design automated methods specific to FISH images.

There are several problems associated with using existing automated digital image analysis techniques and methods for analyzing FISH images for determining known medical conditions. One problem is that existing digital image analysis techniques are typically used only for counting fluorescent color signals in biological samples such as groups of cells from a tissue sample. Another problem is the manual method used is time consuming and prone to error including missing areas of the slide including tumor or cancer cells.

There have been attempts to solve some of the problems associated with manual methods for analyzing FISH samples. For example, Another Isis a color fluorescence (FISH) imaging system from MetaSystems, of Altussheim, Germany, provides automatic image acquisition functionality that captures low light level fluorescent images. Isis provides a variety of tools to enhance, edit, annotate, archive, measure and print the fluorescent images.

In U.S. Pat. No. 6,087,134 entitled “Method for analyzing DNA from a rare cell in a cell population,” that issued to Saunders, teaches “Methods are provided for analyzing DNA of a rare cell in a cell population. In one embodiment, the method involves covering a cell monolayer with a photosensitive material. By illuminating the area over a cell of interest, the material is solidified, permitting manipulation of the underlying cell and/or protection of the cell from DNA-inactivating agents that destroy DNA in other cells in the monolayer. In another embodiment, the monolayer is overlaid with a solid material that becomes soluble when illuminated. By illuminating the area over a cell of interest, that cell can be specifically exposed and DNA from the cell amplified. The methods are particularly useful for analyzing fetal cells found in maternal blood.”

In U.S. Pat. No. 6,165,734, entitled “In-situ method of analyzing cells,” that issued to Garini, et al. teaches “A method of in situ analysis of a biological sample comprising the steps of (a) staining the biological sample with N stains of which a first stain is selected from the group consisting of a first immunohistochemical stain, a first histological stain and a first DNA ploidy stain, and a second stain is selected from the group consisting of a second immunohistochemical stain, a second histological stain and a second DNA ploidy stain, with provisions that N is an integer greater than three and further that (i) if the first stain is the first immunohistochemical stain then the second stain is either the second histological stain or the second DNA ploidy stain; (ii) if the first stain is the first histological stain then the second stain is either the second immunohistochemical stain or the second DNA ploidy stain; whereas (iii) if the first stain is the first DNA ploidy stain then the second stain is either the second immunohistochemical stain or the second histological stain; and (b) using a spectral data collection device for collecting spectral data from the biological sample, the spectral data collection device and the N stains are selected such that a spectral component associated with each of the N stains is collectable.”

In U.S. Pat. No. 6,524,798, entitled “High efficiency methods for combined immunocytochemistry and in-situ hybridization,” that issued to Goldbard, et al. teaches “the invention provides a high efficiency method for combined immunocytochemistry and in situ hybridization. In one aspect, the method is used to simultaneously determining a cell phenotype and genotype by contacting a cell with an antigen-specific antibody bound to a ligand, contacting the cell with polynucleotide probe to form a complex of the probe and a nucleic acid in the cell, contacting the cell with a detectably labeled anti-ligand, and detecting the polynucleotide-probe complex and the anti-ligand-ligand complex. The presence of the anti-ligand is correlated with the presence of the antigen and the presence of the probe-nucleic acid complex is correlated with the presence of the nucleic acid in the cell.

U.S. Pat. No. 6,803,195 entitled “Facile detection of cancer and cancer risk based on level of coordination between alleles. ” that issued to Avivi, et al., teaches, “There is provided a method for the detection of cancer and cancer risk by analyzing the coordination between alleles within isolated cells whereby an alteration in an inherent pattern of coordination within isolated cells corresponds to cancer or cancer risk. Also provided is a method of determining the genotoxic effect of various environmental agents and drugs by assaying isolated cells to determine the coordination between alleles following in-vivo and/or in-vitro exposure to the various agents. Allelic coordination characters are selected from replication, conformation, methyalation and acetylation patterns. A diagnostic test for detecting cancer or the risk of cancer having an allelic replication viewing device for viewing the mode of allelic replication of a DNA entity, a standardized table of replication patterns and an analyzer to determine an altered pattern of replication, whereby such altered pattern is a cancer characteristic is also provided. There is also provided a method for differentiating between hematological and solid malignancies by following mono allelic expressede sequences and analyzing the replication status of the sequences to distinguish between hematological and solid malignancies.”

Yet another example is a product called “CytoVisionFISH” from Applied Imaging Corporation, of San Jose, Calif. FISH is integrated in CytoVision's capture and analysis tools. FISH color channel capture can be used in both transmitted and fluorescent light. Once captured, a user can start analyzing or karyotyping immediately.

Yet an example is a product called “GenoSsensor Reader” from Vysis Inc., a subsidiary of Abbott Laboratories, of Downers Grove, Ill. This product utilizes high resolution imaging technology to automatically acquire fluorescent images. The reader software interprets the array image and determines gene copy number changes. GenoSensorReader also provides researchers with the ability to analyze genomic changes and to correlate them with the disease process.

However, none of these solutions solve all of the problems with automated FISH analysis of digital images. Thus, it is desirable to provide an automated FISH image analysis system that not only provides automated analysis of biological samples based on analyzing fluorescence color signals, but also makes provision for modifying analysis parameters according to the variations and deviations in the fluorescence marker dye and requirements of the life science experiment.

### SUMMARY OF THE INVENTION

In accordance with preferred embodiments of the present invention, some of the problems associated with automated FISH analysis systems are overcome. A method and system for digital image based fluorescent in situ (FISH) analysis is presented.

Luminance parameters from a digital image of a biological tissue sample to which a fluorescent compound (e.g., LSI-HER-2/neu and CEP-17 dyes) have been applied are analyzed to determine plural regions of interest. Fluorescent color signals in the plural regions of interest including plural cell nuclei are identified, classified and grouped into plural groups. Each of the plural groups is validated based on pre-defined conditions. A medical diagnosis or prognosis or medical, life science or biotechnology experiment conclusion determined using a count of plural ratios of validated fluorescent color signals within each of the cell nuclei within the plural groups.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary automated digital FISH image analysis system;

FIG. 2 is a flow diagram illustrating an automated method for FISH digital image analysis;

FIG. 3 is a block diagram of an exemplary FISH digital image;

FIG. 4 is a block diagram illustrating plural regions of interest detected in the exemplary FISH digital image of FIG. 3;

FIG. 5 is a block diagram illustrating plural luminance signals detected from the exemplary FISH digital image of FIG. 3;

FIG. 6 is a block diagram illustrating exemplary plural signal clusters detected from the exemplary FISH digital image of FIG. 3;

FIG. 7 is a flow diagram illustrating an automated method for formulating medical conclusion from digital FISH images;

FIG. 8 is a block diagram illustrating an automated method for FISH image analysis of digital images; and

FIG. 9 is a block diagram illustrating an exemplary flow of data in the FISH analysis system of FIG. 1.

### DETAILED DESCRIPTION OF THE INVENTION

### Exemplary Fluorescence In Situ Hybridization (FISH) Analysis System

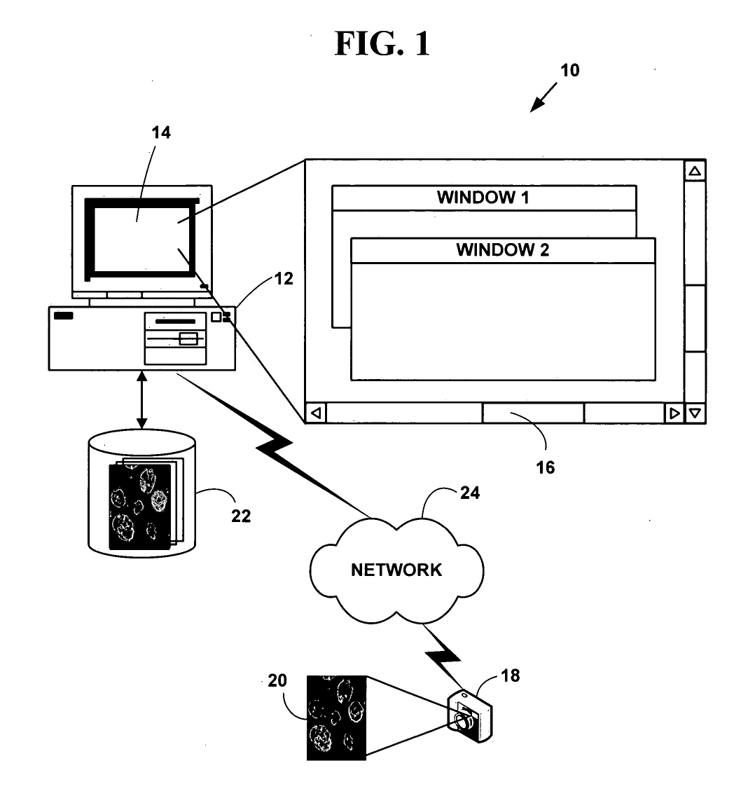

FIG. 1 is a block diagram illustrating an exemplary automated fluorescence in situ hybridization (FISH) analysis system 10. The exemplary system 10 includes one or more computers 12 with a display 14 (one of which is illustrated). The display 14 presents a windowed graphical user interface (“GUI”) 16 with multiple windows to a user. The system 10 may optionally include an optical or fluorescent microscope or other magnifying device (not illustrated in FIG. 1).

As is known in the art, a conventional “optical microscope” uses light to illuminate a sample and produces a magnified image of the sample. A “fluorescence microscope” uses a much higher intensity light to illuminate the sample. This light excites fluorescent compounds in the sample, which then emit light of a longer wavelength. A fluorescent microscope also produces a magnified image of the sample, but the image is based on the second light source, the light emanating from the fluorescent species, rather than from the light originally used to illuminate, and excite, the sample.

The system 10 further includes a digital camera 18 (or analog camera) used to provide plural digital images 20 in various digital images or digital data formats. One or more databases 22 (one or which is illustrated) include biological sample information in various digital images or digital data formats. The one or more database 22 may also include raw and processed digital images and may further include knowledge databases created from automated analysis of the digital images 20, report databases and other types of databases as is explained below. The one or more databases 22 may be integral to a memory system on the computer 12 or in secondary storage such as a hard disk, floppy disk, optical disk, or other non-volatile mass storage devices. The computer 12 and the databases 22 may also be connected to an accessible via one or more communications networks 24.

The one or more computers 12 may be replaced with client terminals in communications with one or more servers, or with personal digital/data assistants (PDA), laptop computers, mobile computers, Internet appliances, one or two-way pagers, mobile phones, or other similar desktop, mobile or hand-held electronic devices.

The communications network 24 includes, but is not limited to, the Internet, an intranet, a wired Local Area Network (LAN), a wireless LAN (WiLAN), a Wide Area Network (WAN), a Metropolitan Area Network (MAN), Public Switched Telephone Network (PSTN) and other types of communications networks 24.

The communications network 24 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 24 may include one or more servers and one or more web-sites accessible by users to send and receive information useable by the one or more computers 12. The one ore more servers, may also include one or more associated databases for storing electronic information.

The communications network 24 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is know in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 19 and the present invention is not limited to TCP/UDP/IP.

The one or more database 22 include plural digital images 20 of biological samples taken with a camera such as a digital camera and stored in a variety of digital image formats including, bit-mapped, joint pictures expert group (JPEG), graphics interchange format (GIF), etc. However, the present invention is not limited to these digital image formats and other digital image or digital data formats can also be used to practice the invention.

The digital images 20 are typically obtained by magnifying the biological samples with a microscope or other magnifying device and capturing a digital image of the magnified biological sample (e.g., groupings of plural magnified cells, etc.).

An operating environment for the devices of the exemplary system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

The term “sample” includes cellular material derived from a biological organism. Such samples include but are not limited to hair, skin samples, tissue samples, cultured cells, cultured cell media, and biological fluids. The term “tissue” refers to a mass of connected cells (e.g., central nervous system (CNS) tissue, neural tissue, or eye tissue) derived from a human or other animal and includes the connecting material and the liquid material in association with the cells. The term “biological fluid” refers to liquid material derived from a human or other animal. Such biological fluids include, but are not limited to, blood, plasma, serum, serum derivatives, bile, phlegm, saliva, sweat, amniotic fluid, and cerebrospinal fluid (CSF), such as lumbar or ventricular CSF. The term “sample” also includes media containing isolated cells. One skilled in the art may determine the quantity of sample required to obtain a reaction by standard laboratory techniques. The optimal quantity of sample may be determined by serial dilution.

The term “biological component ” include, but not limited to nucleus, cytoplasm, membrane, epithelium, nucleolus and stromal. The term “medical diagnosis” includes analysis and interpretation of the state of tissue material in a biological fluid. The interpretation includes classification of tissue sample as “benign tumor cell” or “malignant tumor cell”. Interpretation also includes quantification of malignancy.

As is also known in the art, “Mitosis” is a process that facilitates the equal partitioning of replicated chromosomes into two identical groups. Mitosis is a last stage of cell cycle during which cells divide into two cells. In a typical animal cell, mitosis can be divided into four principal stages: (1) “Prophase:” where cell chromatin, diffuse in interphase, condenses into chromosomes. Each chromosome has duplicated and now consists of two sister chromatids. At the end of prophase, the nuclear envelope breaks down into vesicles; (2) “Metaphase:” where the chromosomes align at the equitorial plate and are held in place by microtubules attached to the mitotic spindle and to part of the centromere; (3) “Anaphase:” where the centromeres divide. Sister chromatids separate and move toward the corresponding poles; and (4) Telophase: where the daughter chromosomes arrive at the poles and the microtubules disappear. The condensed chromatin expands and the nuclear envelope reappears. The cytoplasm divides, the cell membrane pinches inward ultimately producing two daughter cells (e.g., “Cytokinesis”).

Automated Fluorescence In Situ Hybridization (FISH) Analysis Method

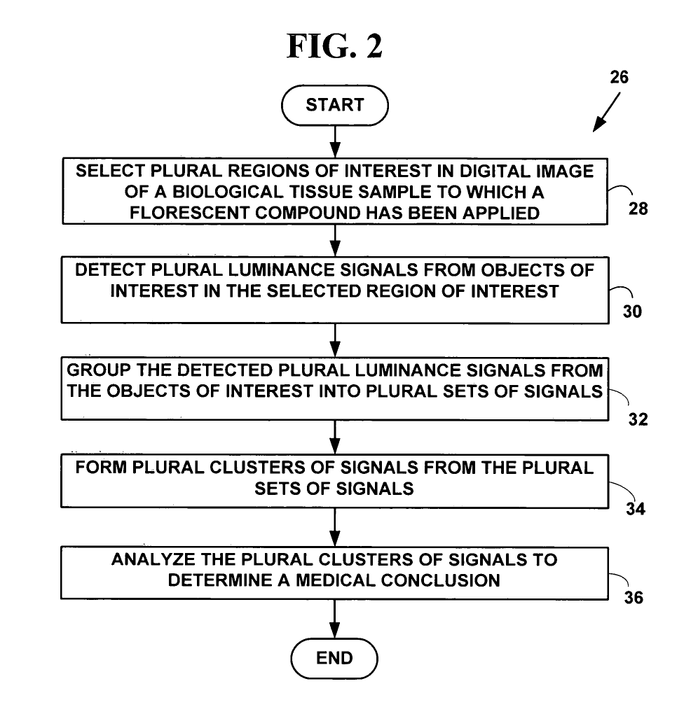

FIG. 2 is a flow diagram illustrating an exemplary Method 26 for automated biological sample analysis. At Step 28, plural regions of interest are selected in a digital image of a biological tissue sample to which a fluorescent compound has been applied. At Step 30, plural luminance signals are detected from plural objects of interest in the selected plural regions of interest. At Step 32, the plural luminance signals detected from the plural objects of interest are grouped into plural sets of signals. At Step 34, plural clusters of signals are formed from the plural sets of signals. At Step 36, the clusters of signals are analyzed to determine a medical conclusion.

Method 26 may further include an additional Step 27 (Not illustrated in FIG. 2) creating one or more reports related to the medical conclusion and presenting the digital image and the one or more types of reports generated for the medical conclusion on the GUI 14. However, Method 24 is not limited to this embodiment and Method 24 can be practiced with out Step 27.

Method 26 may be specifically used by pathologists and other medical personnel to automatically analyze a tissue sample to make a medical diagnosis or prognosis. However, the present invention is not limited to such an application and Method 20 may also be used for other purposes.

Method 26 may also be used for automatically determining diagnostic saliency of digital images for cells. This method can be used for automatically determining diagnostic saliency of digital images includes using one or more filters (e.g., Equation (1), pixel thresholds, etc.) for evaluating digital images 20. Each filter is designed to identify a specific type of morphological parameter of a mitotic cell.

Method 26 may also be used for automatically quantitatively analyzing biological samples. This method is use for automatically quantitatively analyzing relevant properties of the digital images, and creating interpretive data, images and reports resulting from such analysis. Method 26 may be specifically applied to analyze a tissue sample for cancer cells and make a medical diagnosis using Fluorescence In Situ Hybridization (FISH) analysis. However, the present invention is not limited to such an application and Method 26 may be used for other purposes.

Method 26 is illustrated with one exemplary embodiment. However, the present invention is not limited to such an embodiment and other embodiments can also be used to practice the invention.

In such an exemplary embodiment at Step 28, plural region of interests in a digital image of human tissue sample with plural cells to which a fluorescence compound has been applied are selected. For example, a determination of a presence of amplification for a HER-2/neu oncogene using FISH analysis is in part based on counting of fluorescence signals for LSI-HER-2/neu (i.e., red/orange signals) and CEP-17 (i.e., green signals) included within an inter-phase cell nuclei (e.g., stained with DAPI, blue or propidium orange, red, etc.) of invasive carcinoma cells.

Current guidelines for non-amplified and amplified cells are based on enumeration of at least twenty inter-phase nuclei from tumor cells per target sample reported as a ratio of average LSI-HER-2/neu counts that of CEP-17 counts. That is a ratio of red/orange signal value counts to average green signal value counts.

A ratio of LSI-HER-2 to CEP 17 orange to green indicates an amplification level. A ratio of one is considered as non-amplified. A ratio in the range of one to two is low-amplified. A ratio in the range of two to four is moderately amplified. A ratio above four is highly amplified.

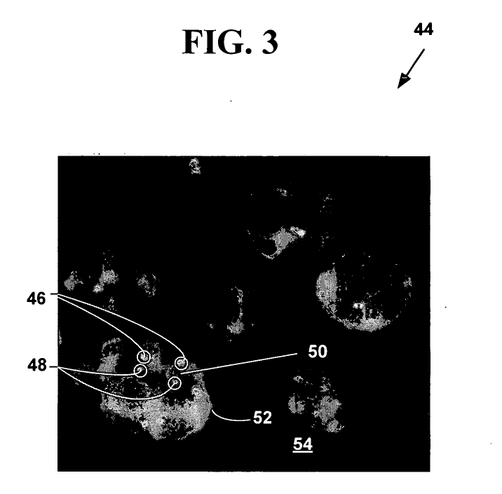

FIG. 3 is a block diagram 44 of an exemplary FISH digital image. FIG. 3 illustrates green and yellow 46 signals and red and orange 48 signals in a cell nucleus 50 in one exemplary cell 52 and a dark background portion 54 of a digital image 20 for a biological tissue sample to which a fluorescent compound has been applied. FIG. 3 illustrates

Cell nuclei 50 in FISH images occupy small areas compared to background 52, which is normally dark. Signals are even smaller compared to nucleus in size and are counted only if a fluorescent signal is detected inside a nucleus.

In one embodiment of the invention, at Step 28, plural Regions of Interest (ROI) are detected based on digital image statistics. However, the present invention is not limited to using image statistics to determine an ROI and other methods can also be used to practice the invention.

In such an embodiment, a statistical mean and a standard deviation in plural color planes are independently calculated. Let meanR, meanG, meanB be a mean value in red, green and blue digital image color planes respectively. Let STDr, STDg, STDb be a standard deviation value in the red, green and blue digital image color planes respectively. ROIs are selected using red color plane pixels from the digital image. A pixel at (x,y) is considered to be in ROI as is illustrated in Equation 1.
(x,y)=ROI if (Rxy, Gxy, Bxy) are such that Colorxy>meanColor+STDColor/2 (1)
wherein Color is selected dependent upon a type of fluorescent compound used.

In one embodiment a red color plane is used (i.e., Color=red in Equation (1)) and LSI-HER-2/neu and CEP-17 fluorescent staining dyes are used. Equation (2) illustrates determining ROIs in such an embodiment.
(X,Y)=ROI if (Rxy, Gxy, Bxy) are such that Rxy>meanR+STDr/2 (2)

However, the present invention is not limited to this embodiment and other embodiments can also be used to practice the invention depending on the type of fluorescent compound used.

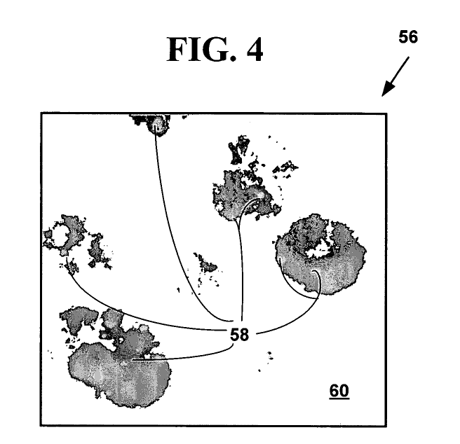

FIG. 4 is a block diagram 56 illustrating plural regions of interest 58 detected at Step 28. The orange area 60 is background area and is not a region of interest.

In one embodiment, pixels in the plural detected region of interest identified fluorescent signal pixels are processed to remove noise. There are typically three reasons for noise in digital FISH images. One reason is cloud of orange color in a background color. A second reason is signals are diffused if a cell chromosome is on a lower edge of nucleus. A third reason is that there are large spots of bright light due to biological artifacts. Noise due to the cloud of orange signals is reduced by dilating valid colored pixels in the areas of interest. In the present embodiment, blue colored pixels and pink colored pixels a region of interest 58 are dilated into a cloud of background color 60, namely orange. This step results in a pool of connected blue components.

Returning to FIG. 2 at Step 30, plural luminance signals are detected from plural objects of interest in the detected plural regions of interest 58.

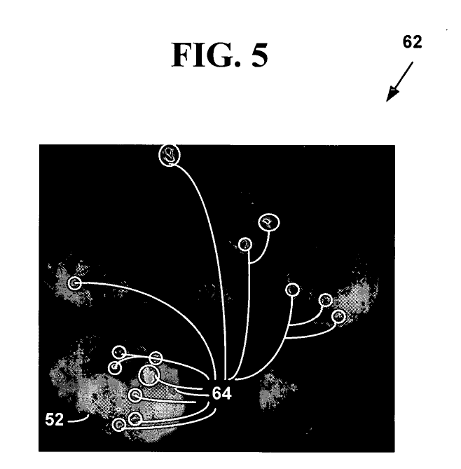

FIG. 5 is a block diagram 62 illustrating plural luminance signals 64 detected from the plural objects of interest.

Ideally the luminance signals should be exhibiting distinct colors such as red, orange, green and blue. In general, FISH digital images are very noisy in the sense there can be a cloud of orange color background, diffused signals if a chromosome is on a lower edge of nucleus, large spots of bright light due to artifacts. As a result noise removal methods (e.g., one or more filtering techniques) are applied to eliminate these unwanted signals. Noise is eliminated in a cloud of orange signals by dilating blue colored pixels in a pseudo colored image. This results in a pool of connected blue components. In this pool of connected blue components those that are too big (e.g., more than 500 pixels) are eliminated. The blue components less than 10 pixels are marked as orange signals. Larger components in the range of 10 to 500 pixels are processed with a higher level threshold value.

Elimination of large connected components in gray-green and pink color is also completed. Gray-green components in the range 10 to 500 pixels represent the yellow signal (i.e., or one orange and one green signal at the same place). Pink components in the range 10 to 500 pixels represent green signal. After identifying valid signals, other connected components, irrespective of color and size are eliminated. There are also variations in the background in the nucleus within a region of interest. These variations are often due to problems of a capturing device, thickness of the sample, etc. In such cases, image statistics used for detecting signals may not be entirely accurate. A consequence of this error is missed signals in some nuclei and excess signals in other nuclei. Such errors are significantly reduced or completely eliminated at Step 28.

For FISH analysis, fluoresce signals are visible as bright color dots on a dark background (See FIG. 3). However in practice variations exist. Some dots get diffused into clouds. In some cases orange clouds become very large with hardly any visible bright spots. Green color dots are typically more conspicuous compared to orange dots. Detection of color dots is independent of variations of images using image statistics of region of interest, mean “M” and standard deviation “S” for three color planes. M and S of histogram of red, green and blue color planes are computed. Minimum values of signals in each color plane are determined. The mean and standard deviation of respective color planes in the region of interest are used. Table I illustrates criteria used to detect the plurals signals at Step 30. However, the present invention is not limited to the criteria illustrated in Table 1 and other criteria can also be used to detect signals to practice the invention.

TABLE 1
A pixel belongs to an Orange signal if a red component is at least a green
component and the red component is more than a minimum level. All such
pixels are pseudo colored blue.
A pixel belongs to Yellow signal if both red and green components are
more than respective minimum values and red component is in the range
of 0.7 to 1 .3 times green component. Such pixels are pseudo colored
Greyish-Green.
A pixel belongs to Green signal if the green component of the pixel is
more than red component of the pixel and green component of the pixel
is more than 0.75 times blue component and green component is more
than the minimum level. These pixels are colored pink.

All other color connected components, not satisfying any of the conditions in Table 1 are deleted from further analysis

Returning to FIG. 2 at Step 32, plural luminance signals from the objects of interest are grouped into plural sets of signals. A set of signals independent of color (i.e., orange, green or yellow signals) are identified for each nucleus in the digital image. A distance between each of these signals is used to form groups of signals. A distance of about 100 pixels differentiates well between inter-nucleus signals from intra-nucleus signals. However, other method can also be used and the present invention is not limited to using pixel distances.

At Step 34, plural clusters of signals are formed from the plural sets of signals.

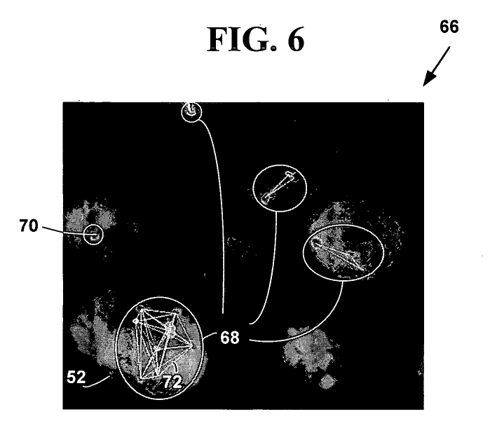

FIG. 6 is a block diagram 66 illustrating exemplary plural clusters 68.

In FIG. 6, an exemplary green fluorescent signal 70 in a nucleus is not counted as there is no other orange colored fluorescent signal in the nucleus 72 (See Table 2). Groups of fluorescent signals in a cluster in each nucleus are represented by a mesh 74.

Criteria used for grouping signals works well for nuclei that are a pre-determined distant apart. In order to form further subgroups, called “clusters,” a dark boundary between any two distinct nuclei is used to form clusters. Even in the case of touching nuclei, a dark region can be detected between a pair of signals. Pairs of signals are considered, irrespective of its color in each group and then check is made to determine if there is a dark region between them. This is done by checking if each color component of every pixel in the corridor joining two given signals. If all three components for any pixel fall below the mean of respective color plane, then there is a dark region between two signals and they belong to two different nuclei. These two signals are placed in two different clusters.

In one embodiment, formed clusters are validated using dual color signal counting conditions illustrated in Table 2. However, the present invention is not limited to validating clusters as is illustrated in Table 2 and other validation techniques can be used to practice the invention. Also the present invention is not limited to validating formed clusters and can be practice without cluster validation.

TABLE 2
Do not count nucleus without at least one signal present from each color.
Count any split signals as one.
Do not count overlapping nuclei if all nuclei are not visible and some
signals are in overlapping area.
Count overlapping nuclei if all nuclei are visible and no signals are
in overlapping area.

At Step 36, the clusters of signals are analyzed to determine a medical diagnosis or medical prognosis. A ratio of orange signals over green signals for each nucleus is calculated in each cluster. A final FISH score is determined as an average of all individual cluster scores. The final FISH score is used to aid in a medical diagnosis or a medical prognosis of selected carcinomas such as breast cancers by pathologists and other medical clinicians.

For example, as was discussed above, a determination of a presence of amplification for a HER-2/neu oncogene using FISH analysis is based on counting and analyzing fluorescence signals for LSI-HER-2/neu and CEP-17 included within an inter-phase cell nuclei of invasive carcinoma cells. This counting and analyzing of the fluorescence signals provides a final FISH score that is used aid in a medical diagnosis or a medical prognosis of selected carcinomas such as breast cancer.

In one embodiment, at Step 36, a medical diagnosis may include a diagnosis of N-stage breast cancer or a medical prognosis such as terminal breast cancer with six months to live. However, the present invention is not limited to this embodiment and other embodiments may be used to practice the invention.

In one embodiment Method 74 is used at Steps 34 and 36. However, the present invention is not limited to this embodiment and other methods may be used at Step 36 to practice the invention.

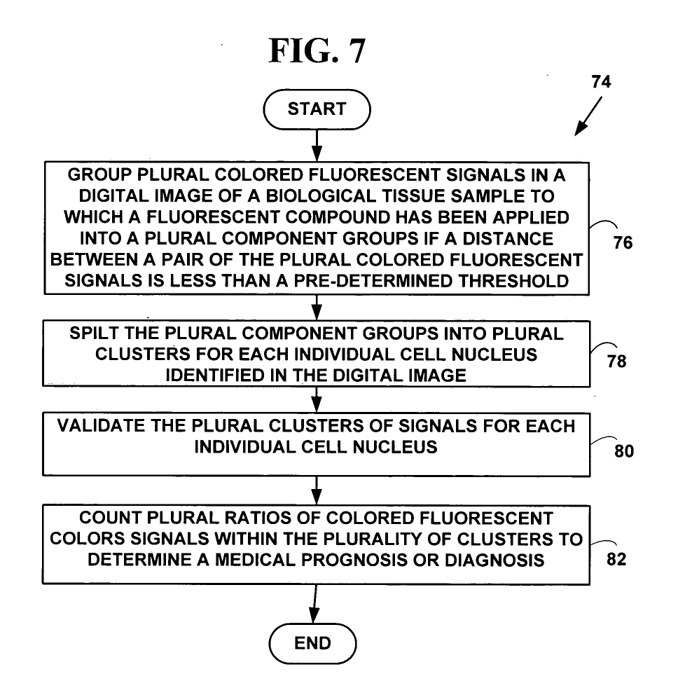

FIG. 7 is a flow diagram illustrating an automated Method 74 for formulating medical a conclusion from digital FISH images. At Step 76, plural colored fluorescent signals in a digital image of a biological tissue sample to which a fluorescent compound has been applied are grouped into plural component groups if a distance between a pair of the plural colored fluorescent signals is less than a pre-determined threshold. At Step 78, the plural component groups are split into plural clusters for each individual cell nucleus identified in the digital image. At Step 80, the plural clusters of signals are validated for each individual cell nucleus. At Step 82, plural ratios of colored fluorescent colors signals within the plurality of clusters are counted to determine a medical prognosis or diagnosis.

Method 74 is illustrated with one exemplary embodiment. However, the present invention is not limited to such an embodiment and other embodiments can also be used to practice the invention.

In such and exemplary embodiment at Step 76, colored fluorescent signals are grouped together into plural component groups if a distance between a pair of the colored fluorescent signals is less than a pre-determined threshold. In one embodiment, the colored fluorescent signals are orange or green or yellow in color. In one embodiment, a pre-determined threshold of 100 pixels is used. This value is related to the average nucleus diameter, which was found to be 100 pixels on experimentation with a large number of samples. However, the present invention is not limited to such an embodiment and other colored signals and pre-determined thresholds can also be used to practice the invention.

At Step 78, a component group is split into plural clusters for each individual cell nucleus. Grouping fluorescent signals works well for nuclei that are far apart in the digital image. In one embodiment, fluorescent signals belonging to two different nuclei might be placed in one group if signals are closer than 100 pixels. Such cases are resolved at Step 78. A line joining a pair of fluorescent signals from two different nuclei will cut across or touch a background portion of the digital image. The fact that there is a dark boundary between any two distinct nuclei is used to split a component group into plural clusters. It is observed that even in the case of touching nuclei, a dark region between a pair of fluorescent signals can be detected. Considering each pair of signals, irrespective of its color in each group presence of a dark region between them is checked. This is done by checking if each color component of every pixel in a narrow band joining two given signals. If all three components for any pixel fall below the mean of respective color plane of the total FISH image, then there is a dark region between two fluorescent color signals and they belong to two different nuclei. These two fluorescent signals are placed in two different clusters.

At Step 80, the plural clusters of signals are validated for each individual cell nucleus. Validation of color signals in each nucleus is completed using a set of rules illustrated in Table 2. However, the present invention is not limited to this embodiment and more or fewer rules can also be used to practice the invention.

At Step 82 a ratio of fluorescent colors signals within the plural clusters are counted to determine a medical conclusion. In one embodiment, plural ratios of orange signals over green signals are counted for each nucleus. A final FISH score is an average of all ratios of all individual nucleus validated at step 80. However, the present invention is not limited to this embodiment and other embodiment can also be used to practice the invention.

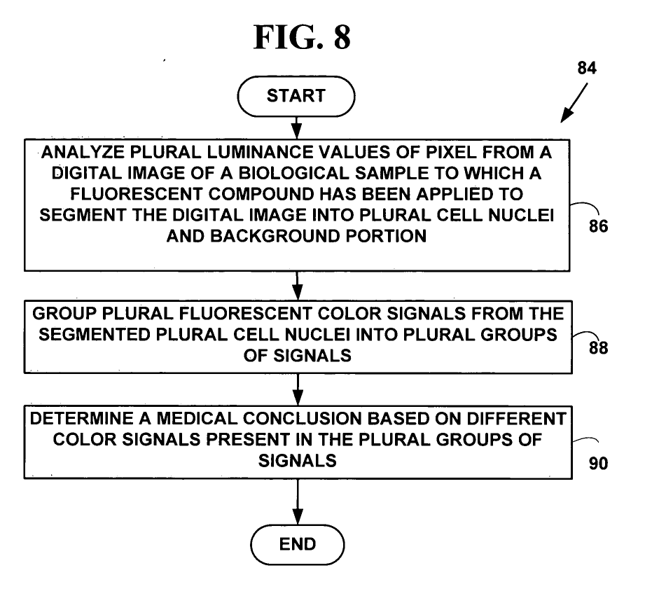

Method 74 may further include an additional Step 83 (Not illustrated in FIG. 8) creating one or more reports related to the medical conclusion and presenting the digital image and the one or more types of reports generated for the medical conclusion on the GUI 14. However, Method 74 is not limited to this embodiment and Method 84 can be practiced with out Step 83.

Methods 26 and 74 are not limited to the pre-determined conditions or pre-determined values described. In another embodiment of Method 26 and 74, other colors of fluorescent signals can also be detected by pre-determining minimum levels in various color planes and ranges of ratios used in pre-determined conditions are used. Minimum values and ranges of ratios are determined from characteristics of fluorescent dyes used.

FIG. 8 is a block diagram illustrating an automated Method 84 for FISH image analysis of digital images. At step 86, plural luminance values of pixel from a digital image of a biological sample to which a fluorescent compound has been applied are analyzed to segment the digital image into plural cell nuclei and background portion. At step 88, plural fluorescent color signals are grouped from the segmented plural cell nuclei into plural groups of signals. At step 90, a medical conclusion (medical diagnosis or prognosis or life science and biotechnology conclusion) is determined based on different color signals present in the plural groups of signals.

Method 84 may further include an additional Step 91 (Not illustrated in FIG. 8) creating one or more reports related to the medical conclusion and presenting the digital image and the one or more types of reports generated for the medical conclusion on the GUI 14. However, Method 84 is not limited to this embodiment and Method 84 can be practiced with out Step 91.

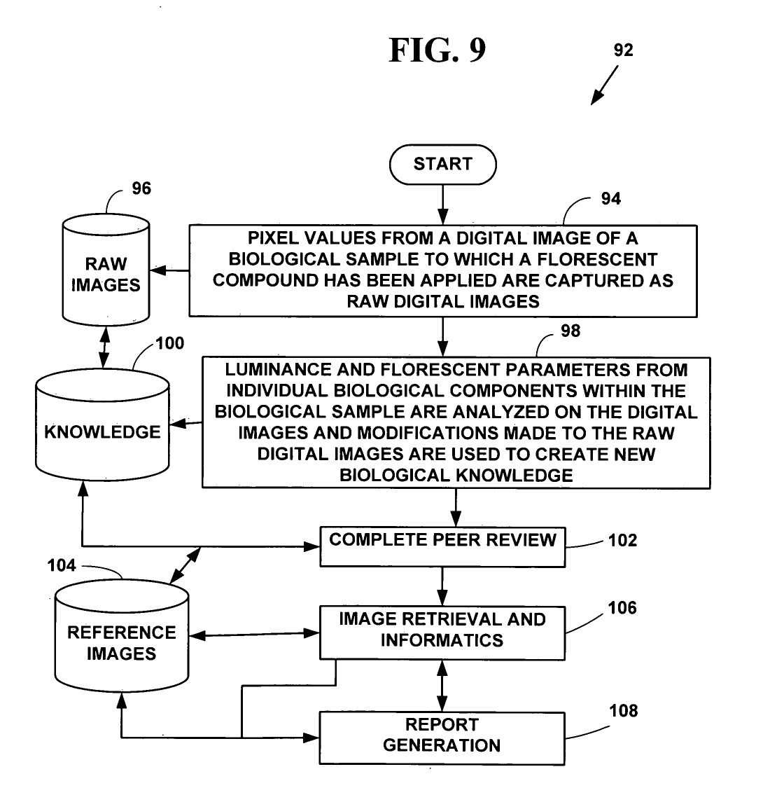

FIG. 9 is a block diagram illustrating an exemplary flow of data 92 in the automated fluorescence in situ hybridization (FISH) analysis system 10. Pixel values from a digital image 20 of a biological sample to which a fluorescent compound has been applied are captured 94 as raw digital images 96. The raw digital images 96 are stored in raw image format in one or more image databases 22. Fluorescent parameters from individual biological components such as cell nuclei within the biological sample are analyzed on the digital image 20 and are used to create new biological knowledge 98 using the methods described herein. The new biological and medical knowledge is stored in a knowledge database 100. Peer review of the digital image analysis and medical, life science and biotechnology experiment results is completed 102. A reference digital image database 104 facilitates access of reference images from previous records of medical, life science and biotechnology experiments at the time of peer review. Contents of the reference digital image database 104, information on the biological sample and analysis of current biological sample are available at an image retrieval, reporting and informatics module 106 that displays information on GUI 14. Conclusions of a medical diagnosis or prognosis or life science and biotechnology experiment are documented as one or more reports. Report generation 108 allows configurable fields and layout of the report. New medical, biological and/or biotechnology knowledge is automatically created and saved.

In one embodiment of the invention, the methods and systems described herein are completed within an Artificial Neural Networks (ANN). An ANN concept is well known in the prior art. Several text books including “Digital Image Processing” by Gonzalez R C, and Woods R E, Pearson Education, pages 712-732, 2003 deals with the application of ANN for classification of patterns.

In one embodiment, an ANN based on FIG. 9 is used for training and classifying cells from automated FISH analysis over a pre-determined period of time. However, the present invention is not limited to such an embodiment and other embodiments can also be used to practice the invention. The invention can be practiced without used of an ANN

The present invention is implemented in software. The invention may be also be implemented in firmware, hardware, or a combination thereof, including software. However, there is no special hardware or software required to use the proposed invention.

The methods and system described herein are used to provide an automated medical conclusion or a life science and biotechnology experiment conclusion is determined from FISH analysis. The method and system is also used for automatically obtaining a medical diagnosis (e.g., a carcinoma diagnosis) or prognosis. The method and system may also be used to provide an automated medical conclusion for new drug discovery and/or clinical trials used for testing new drugs.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

1. An automated method for fluorescence in situ hybridization (FISH) analysis, comprising:
selecting a plurality of regions of interest in a digital image of a biological tissue sample to which a fluorescent compound has been applied;
detecting a plurality of luminance signals from a plurality of objects of interest in the selected plurality of regions of interest;
grouping the detected plurality of luminance signals from the plurality of objects of interest into a plurality of sets of signals;
forming a plurality of clusters of signals from the plurality of sets of signals; and
analyzing the plurality of clusters of signals to determine a medical conclusion.

2. The method of claim 1 further comprising a computer readable medium having stored therein instructions for causing one or more processors to execute the steps of the method.

3. The method of claim 1 further comprising:
generating one or more reports related to the medical conclusion;
presenting the digital image and one or more reports generated for the medical conclusion on a graphical user interface.

4. The method of claim 1 wherein the fluorescent compound comprises fluorescent dyes including LSI-HER-2/neu and CEP-17.

5. The method of claim 1 wherein the biological tissue sample includes a plurality of human cells.

6. The method of claim 5 wherein the plurality of human cells potentially includes one or more human cancer cells.

7. The method of claim 6 wherein the one or more human cancer cells are breast cancer cells.

8. The method of claim 1 wherein the luminance signals include orange, red, green or yellow signals.

9. The method of claim 1 wherein the selecting step includes determining region a plurality of regions of interest with:
(x,y)=region of interest if (Rxy, Gxy, Bxy) are such that Colorxy>meanColor+STDColor/2,
wherein Rxy, Gxy, Bxy, are (x,y) points in red, green and blue color planes respectively for luminance signals in the digital image, meanColor is a mean value in a selected color plane and STDColor is a standard deviation value in the selected color plane.

10. The method of claim 9 wherein a selected color plane for Color is a red color plane and wherein fluorescent compound includes fluorescent dyes comprising LSI-HER-2/neu and CEP-17.

11. The method of claim 1 wherein the selecting step includes determining a region of interest by excluding pixels with a pre-determined threshold which includes determining biological tissue components from background pixels in the digital image.

12. The method of claim 1 wherein the grouping step includes grouping the detected plurality of luminance signals for cell nuclei identified in the plurality of objects of interest that are a pre-determined distant apart.

13. The method of claim 1 wherein the forming step includes:
identifying set of signals independent of color for each cell nucleus identified in the plurality of objects of interest in the digital image; and
determining a plurality of clusters of signals using a pre-determined distance between each of the identified set of signals is used to form groups of signals, wherein the pre-determined distance differentiates between inter-nucleus signals and intra-nucleus signals.

14. The method of claim 1 wherein the forming step includes:
grouping a plurality of colored fluorescent signals into a plurality of component groups if a distance between a pair of the plurality of colored fluorescent signals is less than a pre-determined threshold;
splitting the plurality of component groups into a plurality of clusters for each individual cell nucleus identified from the plurality of objects of interest in the digital image; and
validating the plurality of clusters of signals each individual cell nucleus.

15. The method of claim 1 wherein the analyzing step includes counting pre-determined colored luminance signals from plurality of clusters of signals included within inter-phase cell nuclei identified from the plurality of objects of interest in the digital image.

16. The method of claim 15 wherein the counting step includes counting fluorescence red and orange signals and fluorescence green signals included within an inter-phase cell nuclei from the plurality of objects of interest in the digital image for a biological tissue sample to which LSI-HER-2/neu and CEP-17 fluorescent dyes have been applied.

17. The method of claim 1 wherein the analyzing step includes counting a plurality of ratios of luminescent signals within the plurality of clusters to determine a medical conclusion.

18. An automated method for fluorescence in situ hybridization (FISH) analysis, comprising:
grouping a plurality of colored fluorescent signals in a digital image of a biological tissue sample to which a fluorescent compound has been applied into a plurality of component groups if a distance between a pair of the plurality of colored fluorescent signals is less than a pre-determined threshold;
splitting the plurality of component groups into a plurality of clusters for each individual cell nucleus identified in the digital image; and
validating the plurality of clusters of signals each individual cell nucleus; and
counting a plurality of ratios of colored fluorescent colors signals within the plurality of clusters to determine a medical prognosis or diagnosis.

19. The method of claim 18 further comprising a computer readable medium having stored therein instructions for causing one or more processors to execute the steps of the method.

20. The method of claim 18 wherein the counting step includes counting fluorescence red and orange signals and fluorescence green signals included within an inter-phase cell nuclei in the digital image for a biological tissue sample to which LSI-HER-2/neu and CEP-17 fluorescent dyes have been applied.

21. The method of claim 18 wherein the step of splitting the plurality of component groups into a plurality of clusters for each individual cell nucleus identified in the digital image includes splitting a group of fluorescent signals for each individual nucleus based on a presence of a non-region of interest in between a pair of fluorescent color signals in the group.

22. An automated method for fluorescence in situ hybridization (FISH) analysis, comprising:
analyzing luminance values of a plurality of pixels from a digital image of a biological sample to which a fluorescent compound has been applied to segment the digital image into a plurality of cell nuclei and a background portion;
grouping a plurality of fluorescent color signals from the segmented plurality of cell nuclei into a plurality groups of signals; and
determining a medical conclusion based on different color signals present in each of the plurality of groups of signals.

23. The method of claim 22 further comprising a computer readable medium having stored therein instructions for causing one or more processors to execute the steps of the method.

24. The method of claim 22 wherein the grouping step includes:
identifying one or more color error fluorescent signals within the segmented plurality of cell nuclei related to signal noise or biological tissue artifacts; and
eliminating the one or more identified error color fluorescent signals from further analysis.

25. The method of claim 22 wherein the identifying step includes:
identifying a blue color signal based on pre-determined threshold;
identifying a green color signal based on pre-determined threshold;
identifying a yellow color signal based on pre-determined threshold; and
eliminating the identified blue, green and yellow color signals from further analysis in the segmented plurality of cell nuclei for a biological tissue sample to which LSI-HER-2/neu and CEP-17 fluorescent dyes have been applied.

26. The method of claim 25 wherein eliminating step includes:
eliminating the identified blue, green and yellow color signals color signals based on pre-determined size threshold; and
modifying a color of green color signals adjacent to an yellow color signals.

27. The method of claim 22 wherein the determining step includes counting fluorescence red and orange signals and fluorescence green signals included within a plurality of inter-phase cell nuclei in the segmented plurality of cell nuclei for a biological tissue sample to which LSI-HER-2/neu and CEP-17 fluorescent dyes have been applied.

28. An automated system for fluorescence in situ hybridization (FISH) analysis, comprising, in combination:
a means for selecting a plurality of regions of interest in a digital image of a biological tissue sample to which a fluorescent compound has been applied;
a means for detecting a plurality of luminance signals from a plurality of objects of interest in the selected plurality of regions of interest;
a means for grouping the detected plurality of luminance signals from the plurality of objects of interest into a plurality of sets of signals; and
a means for forming a plurality of clusters of signals from the plurality of sets of signals;
a means for analyzing the plurality of clusters of signals to determine a medical conclusion; and
a means for creating one or more reports related to the medical conclusion, for presenting the digital image and the one or more types of reports generated for the medical conclusion on a graphical user interface.

29. An automated system for fluorescence in situ hybridization (FISH) analysis, comprising, in combination:
a database including a plurality of digital images of a plurality of biological samples to which a fluorescent compound has been applied;
a software module for analyzing luminance values of a plurality of pixels from a digital image of a biological sample to which a fluorescent compound has been applied to segment a digital image into a plurality of cell nuclei and a background portion, for identifying and grouping fluorescent color signals from the segmented plurality of cell nuclei into a plurality groups of signals, for validating the plurality of groups of signals for each cell nucleus in the plurality of cell nuclei and for determining a medical conclusion based on different color signals present in each of the plurality of groups of signals; and
a software module for generating one or more reports related to the medical conclusion, for presenting a digital image and the one or more types of reports generated for the conclusion on a graphical user interface.
